(19) United States
(12) Patent Application Publication
(10) Pub. No.: US 2010/0262499 A1
(43) Pub. Date: Oct. 14, 2010

(54) Systems and methods for controlling initialization of advertising campaigns

(75) Inventors: Niklas Karlsson, Mountain VIew, CA (US); Li Yang, Mountain View, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Platform-A, Inc.

(21) Appl. No.: 12/385,554

(22) Filed: Apr. 10, 2009

(51) Int. Cl. G06Q 30/00; G06Q 99/00

(52) U.S. Cl. 705/14.72; 705/400

(57) ABSTRACT

A system is provided for controlling initialization of an online advertising campaign. The system includes a sensor configured to determine current performance of the online advertising campaign and a memory for storing performance information obtained by the sensor, a set of campaign initialization controller instructions, a campaign volume model, and a network average time-of-day pattern. The system also includes an estimator configured to predict future campaign performance based on the performance information obtained by the sensor, the campaign volume model, and the network average time-of-day pattern. The system also includes an initialization controller configured to generate a bid allocation control signal and generate a bid price control signal based on the future campaign performance predicted by the estimator, according to the instructions stored in the memory. A method for controlling initialization of an online advertising campaign is also provided.

### TECHNICAL FIELD

The embodiments described below relate generally to systems and devices for controlling online advertising campaigns, and more specifically, to systems and devices for initialization of online advertising campaigns.

### BACKGROUND

Since the early 1990's, the number of people using the World Wide Web has grown at a substantial rate. As more users take advantage of the World Wide Web, they generate higher and higher volumes of traffic over the Internet. As the benefits of commercializing the Internet can be tremendous, businesses increasingly take advantage of this traffic by advertising their products or services on-line. These advertisements may appear in the form of leased advertising space (e.g., “banners”) on websites, which are comparable to rented billboard space in highways and cities, or commercials broadcasted during television or radio programs.

Advertisers may create online advertising campaigns that include many advertisements to be placed on websites during a specified period of time. For example, an automobile company may design several advertisements for a new model and may wish to have the advertisements placed during a three-week period around the launch of the new model. Each time one of the advertisements is shown to a user is known as an “impression.” When shown the advertisement, the user may select, or “click,” on the advertisement or may take another “action” such as completing an online form to request more information. If the user later purchases the new model automobile, the purchase is referred to as a “conversion” of the impression.

Advertisers may be interested in impressions (e.g., if they are trying to increase awareness of a brand), clicks (e.g., if they are trying to provide more information about a product), or conversions (e.g., if they are trying to make sales or get new users to sign up for services). Advertisers may pay based on, for example, impressions, clicks, or conversions over the course of an advertising campaign. An advertiser may have a spending plan that specifies how the advertiser wishes to spend its budget during a campaign. For example, the advertiser may wish to spend money only on certain days during the campaign, or may wish to spend evenly over every day of the campaign.

As a result, various techniques are used to control online ad delivery within and among advertising campaigns. In certain advertising networks, ad servers receive impression requests from publishers. The ad servers then group ad requests from various campaigns according to the impressions that they “target” based on a specific combination of attributes defined by the ad request. In addition to targeting requirements, each ad request includes a “bid price” and a “bid allocation”. The bid price is the amount of money offered by the ad request for the targeted impression. The bid allocation is the ratio (e.g., value from 0 to 1) of targeted inventory the ad campaign is willing to purchase at the bid price. The list of ads that target a certain impression request are sorted in descending order according to their bid price, and then placed in groups such that the sum of their bid allocations equals 1. If the ad request with the highest bid price has a bid allocation of 1, it will always win the impression. Such ad delivery methods ensure that the ad with the greatest expected value is able to purchase as much inventory as desired. These methods also reveal both the marginal value of the impression inventory, and the amount of volume purchased at each price. Under stable campaign operating conditions, the information can be used to build a curve that describes the relationship between price and volume, which may reveal the bid price an advertiser must submit to purchase a desired volume of ad inventory.

When a new online advertising campaign is launched, there is a risk of “over-delivery” of the online advertisements if either of the “bid price” or the “bid allocation” is too high for the prevailing supply and demand curve for the particular online ad or content web site. For example, if the bid price is too high, the bid may fall relatively high in a bid table, and may “out bid” lower priced bids. If the bid allocation is too high, the bid may win too high of a proportion of similarly priced bids. Thus, if either of the bid price or bid allocation is too high at the beginning of a campaign, numerous ads will be delivered (i.e., “over-delivery”), and the budget for a campaign (e.g., $10,000 per month) might be spent within the first 24 hours of the campaign. On the other hand, severe “under-delivery” may occur if either of the “bid price” or the “bid allocation” is too low in the beginning of the campaign “flight.” Specifically, if either of the bid price or bid allocation is too low, there may be “dark days” (i.e., no ad volume is awarded in the day), and it may take several days for a campaign to catch up to desired delivery pacing. These situations may be undesirable to advertising customers that desire for their ads to be delivered smoothly over the course of the ad campaign. Moreover, because of delays inherent in conventional ad delivery systems, it is often difficult to instantaneously start and stop ad campaigns based on real-time metrics of ad delivery. Therefore, there is a need for conducting fast and predictable campaign initialization that achieves smooth delivery from the beginning of the campaign flight, based on estimates of advertising network volume.

The present disclosure is directed to improving the control of advertising on web sites by solving one or more of the above-mentioned challenges.

### SUMMARY

In accordance with one disclosed exemplary embodiment, a system is provided for controlling initialization of an online advertising campaign. The system includes a sensor configured to determine a current condition of the online advertising campaign and a memory for storing the condition obtained by the sensor, a set of campaign initialization controller instructions, a campaign volume model, and a network average time-of-day pattern. The system also includes an estimator configured to predict future campaign performance based on the performance information obtained by the sensor, the campaign volume model, and the network average time-of-day pattern. The system also includes an initialization controller configured to generate a bid allocation control signal and generate a bid price control signal based on the future campaign performance predicted by the estimator, according to the instructions stored in the memory, wherein the bid allocation control signal and bid price control signal are used to adjust future performance of the online advertising campaign.

In accordance with another exemplary embodiment, a computer-implemented method is provided for controlling initialization of an online advertising campaign. The method includes the steps of using a sensor to determine a current condition of the online advertising campaign and storing in a memory, the condition obtained by the sensor, a set of campaign initialization controller instructions, a campaign volume model, and a network average time-of-day pattern. The method also includes predicting future campaign performance based on the condition obtained by the sensor, the campaign volume model, and the network average time-of-day pattern. The method also includes generating a bid allocation control signal; and generating a bid price control signal based on the future campaign performance predicted by the estimator, according to the instructions stored in the memory; wherein the bid allocation control signal and bid price control signal are used to adjust future performance of the online advertising campaign.

### BRIEF DESCRIPTION OF THE DRAWINGS

FIG. 1 depicts a block diagram of an exemplary system on which online advertising campaigns may be controlled, consistent with embodiments of the present invention;

FIG. 2 depicts a flow-chart of an exemplary method for controlling online advertising campaigns, consistent with embodiments of the present invention;

FIG. 3 depicts an exemplary system for controlling online advertising campaigns on the exemplary system of FIG. 1, consistent with embodiments of the present invention;

FIG. 4 depicts a graphical representation of exemplary bid allocation ramp-up schemes; and

FIG. 5 depicts an exemplary method for controlling online advertising campaigns, consistent with embodiments of the present invention.

### DETAILED DESCRIPTION OF THE DRAWINGS

Reference will now be made in detail to exemplary embodiments of the disclosure, examples of which are illustrated in the accompanying drawings. Wherever possible, the same reference numbers will be used throughout the drawings to refer to the same or like parts.

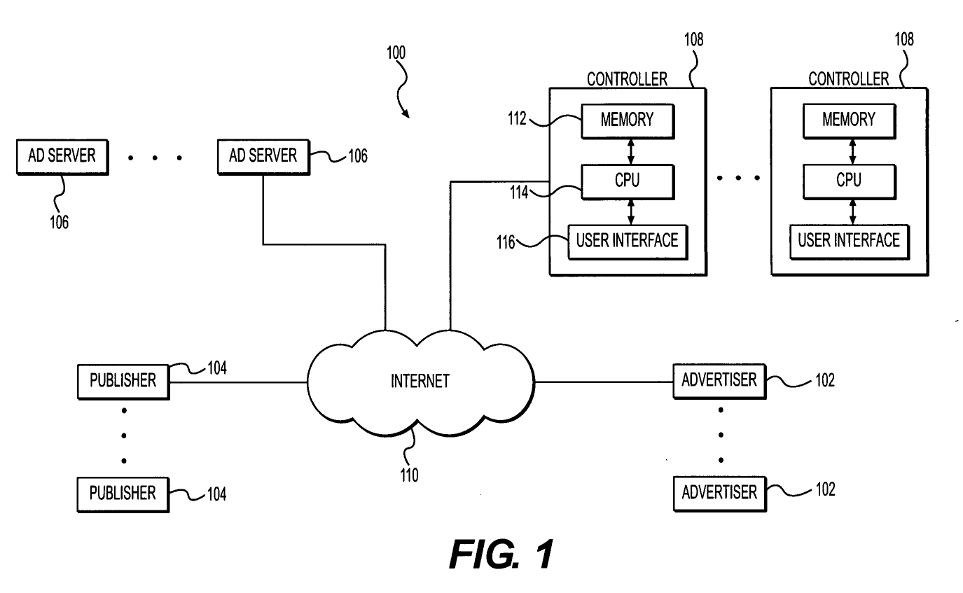

FIG. 1 illustrates an exemplary system 100 for controlling online advertising campaigns. System 100 may include a plurality of advertisers 102, publishers 104, ad servers 106, and controllers 108, in communication with the Internet 110. Advertisers 102 may include any entities having online advertisements (e.g., banner ads, pop-ups, etc.) desired to be delivered to online users. Advertisers 102 may interact with publishers 104, ad servers 106, and/or controllers 108 through computers connected to the Internet 110. Thus, advertisers 102 may be able to communicate advertising campaign information, such as ad information, targeting information, consumer information, budget information, bidding information, etc., to other entities in system 100.

Publishers 104 may include any entities having inventories of available online advertising space. For example, publishers 104 may include online content providers, search engines, e-mail programs, or any other online site or program having online user traffic. Publishers 104 may interact with advertisers 102, ad servers 106, and/or controllers 108 via computers connected to the Internet 110. Thus, publishers 104 may be able to communicate inventory information, such as site information, demographic information, cost information, etc., to other entities in system 100.

Ad servers 106 may include any type of servers configured to process advertising information from advertisers 102 and/or site information from publishers 104, either directly or indirectly. In certain embodiments, ad servers 106 may be remote web servers that receive advertising information from advertisers 102 and serve ads to be placed by publishers 104. Ad servers 106 may be configured to serve ads across various domains of publishers 104, for example, based on advertising information provided by advertisers 102. Ad servers 106 may also be configured to serve ads based on contextual targeting of web sites, search results, and/or user profile information. In some embodiments, ad servers 106 may be configured to serve ads based on control signals generated by controllers 108.

Controllers 108 may include one or more computing systems configured to receive information from entities in system 100, process the information, and generate control signals to be sent to entities in system 100, according to methods described herein. Controllers 108 may include any type or combination of computing systems, such as clustered computing machines and/or servers. In one embodiment, each controller 108 may be an assembly of hardware, including a memory 112, a central processing unit (“CPU”) 114, and/or a user interface 116. Memory 112 may include any type of RAM or ROM embodied in a physical storage medium, such as magnetic storage including floppy disk, hard disk, or magnetic tape; semiconductor storage such as solid state disk (SSD) or flash memory; optical disc storage; or magneto-optical disc storage. CPU 114 may include one or more processors for processing data according to instructions stored in the memory. The functions of the processor may be provided by a single dedicated processor or by a plurality of processors. Moreover, the processor may include, without limitation, digital signal processor (DSP) hardware, or any other hardware capable of executing software. User interface 116 may include any type or combination of input/output devices, such as a display monitor, keyboard, and/or mouse.

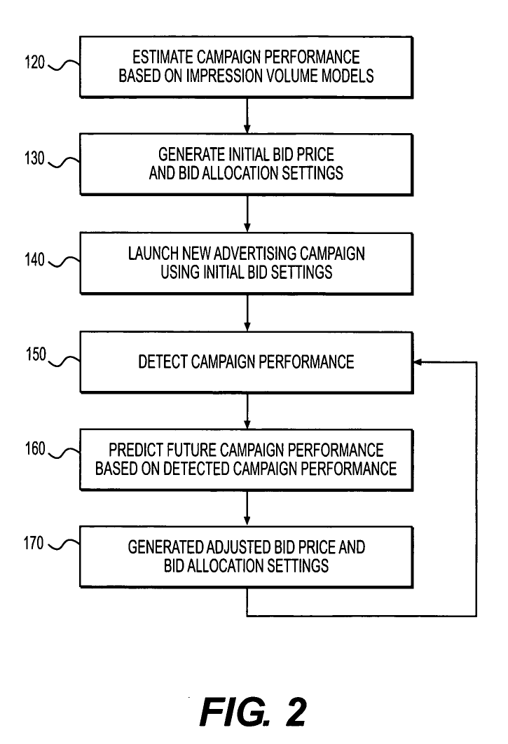

FIG. 2 illustrates an exemplary method for controlling initialization of an online advertising campaign in system 100. Initialization control of a campaign may occur before, during, and/or after the launch of a new advertising campaign “flight,” or when a campaign is re-initialized during a campaign (i.e., “mid-flight”) after having been paused for a period of time. The method may include adjusting the bid price and bid allocation values implemented by a controller of an advertising campaign, to avoid delivering advertisements more quickly or slowly than desired. The bid price and bid allocation values may be adjusted based on estimates of the performance of the campaign, given known parameters of the campaign and of the network in which the campaign is running. For example, the performance estimates may include knowledge about approximate delivery volume as a function of bid allocation values, and knowledge about time-of-day patterns inherent in the network.

Thus, in general, the method for controlling initialization of an advertising campaign may include estimating advertising campaign performance based on volume models (step 120). The volume models may estimate one or more of ad impression volume, click volume, conversion volume, action volume, or any other volume of advertising events. As will be described in more detail below, the volume models may include allocation-based volume estimates and network average time-of-day patterns. The method may also involve defining a bid allocation ramp-up scheme. The ramp-up scheme may linearly or non-linearly increase the bid allocation from a low initial value to a pre-defined maximum bid allocation value. The method may generate initial bid allocation settings based on the ramp-up scheme, and initial bid price settings based on the volume models (step 130). The initial bid allocation settings may define an initial bid allocation value for the campaign, while the initial bid price settings may define an initial bid price value for the campaign. The method may then launch a new advertising campaign using the initial bid price value and bid allocation value (step 140). As soon as the advertising campaign has been launched, the method may detect the performance of the advertising campaign (step 150). For instance, the campaign performance may include measurements of the marginal volume, marginal cost, delivery rate, etc., of the impressions, clicks, conversions, etc., awarded by the ad servers. The method may also consider changes to desired values for the campaign performance (i.e., “reference values”). The method may then predict future campaign performance based on the detected performance of the advertising campaign (step 160). Future campaign performance may be predicted based on the allocation-based volume estimates and time-of-day patterns used to generate the initial settings. The method may then generate adjusted bid price and bid allocation settings based on the predicted future campaign performance (step 170). The method may continue to perform the loop of detecting campaign performance (step 150), predicting future campaign performance (step 160), and generating adjusted bid price and bid allocation settings (step 170), for a predetermined period of time, or until certain conditions are met, as will be described below.

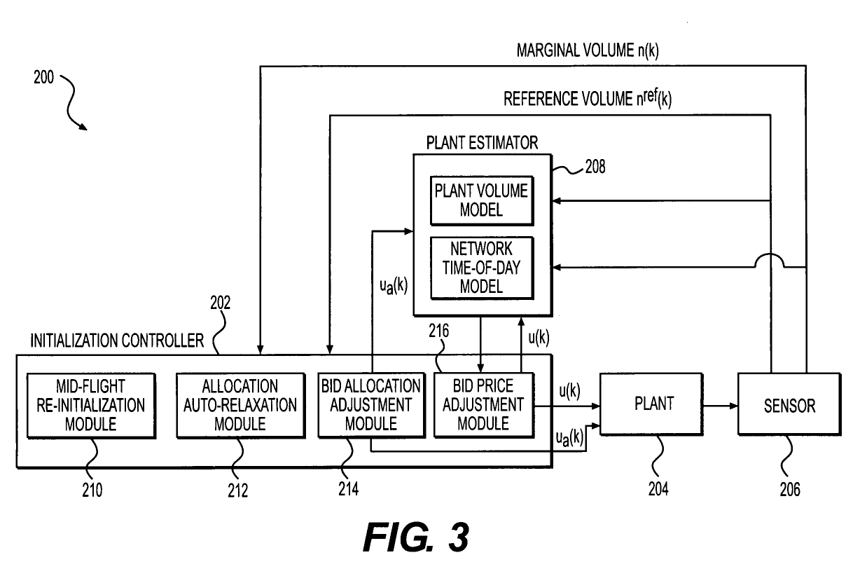

FIG. 3 illustrates a control system 200, which may be implemented by one or more ad servers 106 and controllers 108 in system 100, to perform the method of FIG. 2. In certain embodiments, control system 200 may include a plurality of software modules executed by CPUs 114. In one embodiment, control system 200 may include an initialization controller 202, a plant 204, a sensor 206, and a plant estimator 208. In general, plant 204 may represent the system being controlled, such as one or more advertising campaigns. Sensor 206 may be configured to obtain real-time data about one or more advertising campaigns running in plant 204. For example, sensor 206 may measure operating conditions of plant 204 (i.e., “performance”), such as impression, click, and action volumes. In one embodiment sensor 206 may output a marginal volume n(k) and/or a reference volume n^{ref}(k) awarded to the campaign. Plant estimator 208 may be configured to estimate one or more conditions of plant 204, for example, based on known parameters of the plant, volumes measured by sensor 206, and/or bid price and bid allocation control signals applied to the plant. In one embodiment, plant estimator 208 may estimate plant volume based on an allocation-based plant volume model and a network time-of-day pattern model.

In one embodiment, initialization controller 202 may predict how an advertising campaign will perform when it is introduced into a network. For example, initialization controller 202 may predict a campaign's initial performance based on time-of-day patterns of the network where the campaign will be placed (i.e., a “network time-of-day model”). Initialization controller 202 may also predict a campaign's initial performance based on approximate volume as a function of bid allocation (i.e., an “allocation-based plant volume model”). In certain embodiments, initialization controller 202 may utilize the network's time-of-day pattern and allocation-based plant volume model, as determined by plant estimator 208, to predict the delivery when a new campaign is added to the network or an existing campaign is re-initialized. Initialization controller 202 may also incorporate a bid allocation control ramp-up scheme, as described above, to reduce the over-delivery risk associated with initializing ad campaigns. The initialization controller 202 may be used both in the beginning of a campaign for a fast and safe campaign initialization, and also in the middle of a campaign when there is a system change (such as a reference volume change, campaign entry/withdrawal, etc.) for fast response and good tracking performance. Thus, in certain embodiments, the initialization controller 202 may be configured to adjust bid price and bid allocation simultaneously, based on the outputs of a plurality of modules, as will be described below. The adjusted bid price and/or bid allocation would then be applied to the advertising campaign in plant 204.

In one embodiment, initialization controller 202 may include a mid-flight re-initialization module 210, an allocation auto-relaxation module 212, a bid allocation adjustment module 214, and a bid price adjustment module 216. In general, mid-flight re-initialization module 210 may be configured to activate an initialization sequence during any moment of an advertising campaign, such as during a significant change in reference values, campaign entry/withdrawal, etc. Allocation auto-relaxation module 212 may be configured to avoid under-delivery in an advertising campaign by increasing the maximum bid allocation control signal.

Bid allocation adjustment module 214 may be configured to gradually change a bid allocation of a campaign based on a ramp-up scheme. Bid allocation adjustment module 214 may ramp-up the bid allocation of an advertising campaign from a small initial value, e.g., to minimize risk of over-delivery. For example, bid allocation adjustment module 214 may generate a bid allocation control signal uₐ(k) for each time “k” in the campaign, based on a pre-determined ramp-up function. In particular, bid allocation adjustment module 214 may ramp up bid allocation control signal uₐ(k) from a small value to any specified maximum allocation control signal value to minimize the risk of over-delivery at the beginning of a campaign. Over-delivery occurs, for example, when too many advertisements are placed, making it harder to satisfy an advertiser's campaign goals of even ad placement throughout a campaign.

Bid price adjustment module 216 may be configured to control the bid price in an advertising campaign, e.g., to ensure a delivery goal is met. Bid price adjustment module 216 may generate a bid price control signal u(k) for each time “k” in the campaign, based on the allocation-based plant volume model and network time-of-day models implemented by plant estimator 208, e.g., to meet delivery and revenue goals.

Plant Estimation

Reference will now be made in particular to the operation of plant estimator 208. Plant estimator 208 may incorporate an allocation-based plant volume model and network time-of-day model to generate volume estimates of an ad campaign running in plant 204. Thus, plant estimator 208 may generate future estimates of the volume of ad impressions, clicks, or conversions awarded to a campaign based on knowledge about the network and knowledge about the performance of the campaign. In one embodiment, an allocation-based plant volume model may be based on an assumption that the volume and the bid allocation have a relation defined by the equation, Volume=(BidAllocation)γₐ*(VolumeMax), where γₐ is a constant or slowly varying user-defined parameter.

In one embodiment, the marginal volume of plant 204 may be modeled as a function of an effective allocation control signal and an effective price control signal. In other words, the marginal volume of awarded impressions may be reasonably estimated as a function of the bid prices and the bid allocations of the ad requests generated by the campaign. For example, the relationship between the effective allocation control signal u′ₐ(k), the effective price control signal u′(k), and the marginal volume n(k) can be described by the following equation.

n(k)=(u′ₐ(k))γₐ(u′(k))γe^{β}^{₀}^{+β}^{₁}^{sin(2π k/24+φ}^{₁}^{)+ε(k)} (1)

where k denotes the sampling time of the campaign, given a 1-hour sampling period. In one embodiment, the sampling period may be defined as 15 minutes, or any other suitable sampling period, as desired by a user. The variables u′(k) and u′ₐ(k) may be used to denote the inputs to plant 204 at time k, where, generally, 0≦u′(k)≦1 and 0≦u′ₐ(k)≦1 (although, in some cases u′(k) may be greater than 1 if necessary to achieve desired delivery. In general, u′(k)=u(k−1) and u′ₐ(k)=uₐ(k−1), where u(k−1) and uₐ(k−1) represent the control signals calculated at time k−1. In other words, initialization controller 202 may generate control signals at time k−1, and these signals may be used to determine the campaign's schedule during the hour period k due to any actuation delay in the system. In one embodiment, ε(k) may be a stationary, stable, and mean zero stochastic process, and γₐ, γ, β₀, β₁, and φ₁ may be constant or slowly varying parameters. β₁ and φ₁ may define the magnitude and phase of the time-of-day pattern, respectively. The time-of-day pattern may be defined as a consistent, additive, periodic function extending over a 24 hour period, and reflecting time-variable patterns of user behavior. For example, a time-of-day pattern may be used to represent the number of users who view a webpage over the course of a day, how long users stay on the webpage, times of day with high numbers of users, etc. The time-of-day pattern may reflect the characteristics of an entire advertising network, spanning any number of publisher domains and ad servers.

Bid Price Adjustment

The bid price adjustment module 216 may be configured to generate the bid price control signal u(k) for the campaign during the initialization phase. The bid price control signal may adjust the bid price for ad placements during a campaign. In one embodiment, bid price adjustment module 216 may adjust the bid price control signal u(k) in real time, e.g., to achieve the campaign daily delivery goal, by making use of the campaign's allocation-based plant volume model and the network's time-of-day pattern. Bid price adjustment module 216 may incorporate both a parameter estimation and certain aspects of control theory, as described above with respect to the plant volume model used by plant estimator 208.

In one embodiment, parameter estimation may be performed based on plant model (1), as follows:

$$log ( \frac{n ( k )}{{( {u}_{a}^{′} ( k ) )}^{{γ}_{a}}} ) = γ log ( {u}^{′} ( k ) ) + {β}_{0} + {β}_{1} sin ( 2 π k / 24 + {ϕ}_{1} ) + ɛ ( k ) \qquad ( 2 )$$

The plant model (2) may incorporate estimated network time-of-day patterns, where g(k)=β₁ sin(2π k/24+φ₁) describes the time-of-day pattern, which is set to the network average time-of-day, with:

β₁= β̅₁ and φ₁= φ̅₁ (3)

where β̅₁ and φ̅₁ are the magnitude and phase of the network average time-of-day pattern.

The plant model (2) may also incorporate an allocation-volume gain γₐ, which may be set to:

γₐ= γ̅ₐ (4)

where γ̅ₐ is a network average allocation-volume gain.

The plant model (2) may also incorporate a price-volume gain γ, which may be set to:

γ=1 (5)

although price-volume gain γ may be set to any other desired value other than 1.

In one exemplary embodiment, initial values may be set for the parameters as follows:

$${\overline{β}}_{1} = 1$$

$${\overline{ϕ}}_{1} = \frac{130}{180} π$$

$${\overline{γ}}_{a} = 0.5$$

Substituting (3), (4), and (5) into (2), and denoting:

$$\overline{g} ( k ) = {\overline{β}}_{1} sin ( 2 π k / 24 + {\overline{ϕ}}_{1} )$$

$$y ( k ) = log ( \frac{n ( k )}{{( {u}_{a}^{′} ( k ) )}^{{\overline{γ}}_{a}}} ) - \overline{g} ( k )$$

may provide the following equation:

y(k)−log(u′(k))=β₀+ε(k) (6)

In the above equation, y(k) and u′(k) may be known at each time k, β₀ may be an unknown parameter to be estimated, and ε(k) may be a stationary, stable, and mean zero stochastic process. Least-square estimation (LSE) of equation (6) may then be used in order to obtain an estimate of β₀ at time k, \hat{β}₀(k), which can be used by initialization controller 202. In order to perform the least-square estimation of β₀, equation (6) may be rewritten as follows:

$$Y ( k ) = X ( k ) β + ɛ ( k ) \\ where \\ β = {β}_{0} \\ Y ( k ) = {[ \begin{matrix}y ( 1 ) - log ( {u}^{′} ( 1 ) ) \\ y ( 2 ) - log ( {u}^{′} ( 2 ) ) \\ ⋮ \\ y ( k ) - log ( {u}^{′} ( k ) )\end{matrix} ]}_{k \times 1} \\ X ( k ) = {[ \begin{matrix}1 \\ 1 \\ ⋮ \\ 1\end{matrix} ]}_{k \times 1} \qquad ( 7 )$$

such that \hat{β}₀(k) may be described in terms of X(k) and Y(k) as follows:

$$\begin{matrix}{\hat{β}}_{0} ( k ) = \hat{β} ( k ) \\ = {( {X ( k )}^{T} X ( k ) )}^{- 1} {X ( k )}^{T} Y ( k )\end{matrix}$$

One of ordinary skill in the art will appreciate that β₀ may also be estimated by using a Kalman filter, or any other suitable recursive or non-recursive estimation methods.

In one embodiment, a control theory for defining the bid price control signal u(k) may be obtained using \hat{β}₀, as estimated above, and the plant model, as follows:

u(k)=λu(k−m)+(1−λ)y_{ref}(k)e^{-\hat{β}}^{₀}^{(k)} if mod(k, m)=0

u(k)=u(k−1) if mod(k, m)≠0

where 0≦λ<1 is a design parameter, and y_{ref}(k) is the marginal reference volume.

The control theory for defining the bid price control signal may therefore update the bid price based on the allocation-based plant volume model and the network time-of-day model. In one embodiment, the control signal u(k) may be updated every m hours and may be maintained constant during the m hours. Exemplary values of λ and m may include λ=0 and m=4.

As will be described in more detail below, the above-defined control process may be started by initializing u(0), which can be specified by the operator, or calculated as:

u(0)=min(u_{max 0}, y_{ref}(0)e^{- β̅}^{₀})

where u_{max 0} is the upper bound specified for u(0), and β̅₀ is the prior estimate of β₀ from a network average.

Bid Allocation Adjustment

Referring now in particular to the operation of bid allocation adjustment module 214, bid allocation adjustment module 214 may generate the bid allocation control signal uₐ(k) for the campaign in the initialization phase at each time k. The bid allocation control signal may adjust the bid allocation and, therefore, the percentage of impressions awarded during a campaign. In one embodiment, an objective may be to ramp up the bid allocation control signal uₐ(k) to minimize the risk of over-delivery when a campaign is initialized. The bid allocation control signal ramp-up scheme may be implemented such that uₐ(k) increases linearly or non-linearly from a fairly small value uₐ(k₀) to any specified value u_{a,max}(k₀)(uₐ(k₀)<u_{a,max}(k₀)) in the ramp-up window.

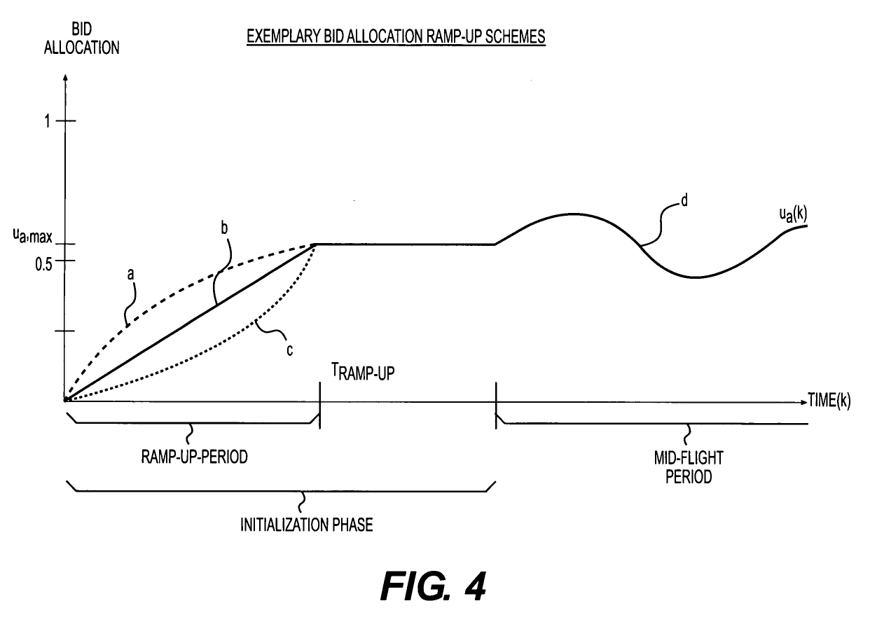

FIG. 4 illustrates a graphical representation of several exemplary bid allocation ramp-up schemes. For example, the bid allocation value may be ramped up from 0 or a small value. The bid allocation value may be ramped up linearly, as suggested by function b, or non-linearly, as suggested by exemplary functions a and C. Of course, the bid allocation may be ramped up from a zero or small value according to any suitable user-defined function. After a ramp-up period, Tᵣₐₘₚ₋ᵤₚ, has elapsed (either after a predetermined time or upon some performance achievement), bid allocation may be adjusted “mid-flight” by a revenue smoothness controller along any non-predefined function d. In some embodiments, the bid allocation may remain constant after the initial ramp-up period. In one exemplary embodiment, the bid allocation control signal uₐ(k) may be defined by the following equation:

$${u}_{a} ( k ) = min ( {u}_{a} ( {k}_{0} ) + \frac{{u}_{a , max} ( {k}_{0} ) - {u}_{a} ( {k}_{0} )}{{T}_{ramp \text{-} up}} ( k - {k}_{0} ) , {u}_{a , max} ( {k}_{0} ) ) for k \geq {k}_{0} \qquad ( 8 )$$

Bid allocation adjustment module 214 may be initialized with the following values for k₀, u_{a,max}(0) and uₐ(0):

$${k}_{0} = 0$$

$${u}_{a , max} ( 0 ) = {u}_{a , max 0}$$

$${u}_{a} ( 0 ) = \frac{{u}_{a , max 0}}{{D}_{f}}$$

In addition, the following parameters may be design parameters specified by the user, including, u_{a,max 0}, which defines the maximum allocation control signal for ramp-up, Tᵣₐₘₚ₋ᵤₚ, which defines the ramp-up window (e.g. in hours), and D_{f}>1. The ramp-up window may specify the time during which allocation is gradually adjusted. In one embodiment, the following exemplary values may be used for the design parameters:

Tᵣₐₘₚ₋ᵤₚ=12

D_{f}=200

Mid-Flight Re-Initialization

Referring now to the mid-flight re-initialization module 210 of FIG. 3, the above-described initialization control scheme may be used not only in the beginning of a campaign, but also in the middle of a campaign (i.e., “mid-flight”), when there is a significant system change, such as reference change or campaign configuration change. A reference change might include, for example, an increase or decrease in the desired daily delivery goal of the campaign. A campaign configuration change might include, for example, changes to the targeting information of ad requests in the campaign. In the beginning of a campaign, the campaign may be controlled by initialization controller 202, which may find the appropriate price/allocation control signals online with desired delivery pacing. After an initialization control phase, the campaign may be passed on to an advertising revenue smoothness controller, which may be initialized with the price/allocation control signals generated by initialization controller 202. Whenever there is a significant change in the system during the campaign flight (e.g., if the reference signals or user preferences are substantially changed, etc.), it may be desirable to activate initialization controller 202 to obtain the desired operating price/allocation control signals faster and achieve desired performance.

Thus, the mid-flight re-initialization module 210 may automatically activate the initialization control scheme whenever there is a significant change in the system. The initialization control scheme may provide mid-campaign adjustments to a bid price and/or bid allocations. For example, when a reference signal is changed by more than certain amount, such as increased by more than 100% or decreased by more than 50%, mid-flight re-initialization module 210 may automatically detect the reference change at time kₘ, and re-initialize the bid allocation adjustment module 214 with the following initialization values:

$${k}_{0} = {k}_{m}$$

$${u}_{a , max} ( {k}_{0} ) = {u}_{a} ( {k}_{m} )$$

$${u}_{a} ( {k}_{0} ) = \frac{{u}_{a} ( {k}_{m} )}{{D}_{f}}$$

Mid-flight re-initialization module 210 may also re-initialize bid price adjustment module 216 with the following initialization value:

u(kₘ)=min(uₘₐₓ₀, y_{ref}(kₘ)e^{- β̅}^{₀}).

Allocation Auto-Relaxation

Referring now to allocation auto-relaxation module 212, the allocation auto-relaxation module 212 may be configured to increase the max allocation control signal value, u_{a,max}, whenever the initial specified value is so small that the control signal is saturated even while the campaign attempts to deliver to avoid saturation of price and/or allocation control signals (i.e., under-delivery). Saturation may occur, for example, when a significant number of similarly-priced competing bids necessitate an increase in bid allocation to obtain delivery. For example, in one embodiment, allocation auto-relaxation module 212 may detect when saturation occurs at a time kₛ, generate a new max allocation control signal value αuₐ(kₛ), where α is a multiplicative factor, α>1, and re-initialize bid allocation adjustment module 214 with the following values:

k₀=kₛ

u_{a,max}(k₀)=min(αuₐ(kₛ),1)

uₐ(k₀)=uₐ(kₛ)

As a result of allocation auto-relaxation module 212, the allocation control signal may be ramped-up to a larger new value, whenever necessary to avoid under-delivery. By increasing the maximum bid allocation value, allocation auto-relaxation module 212 may prevent the ramp-up scheme from causing under-delivery due to low bid allocations.

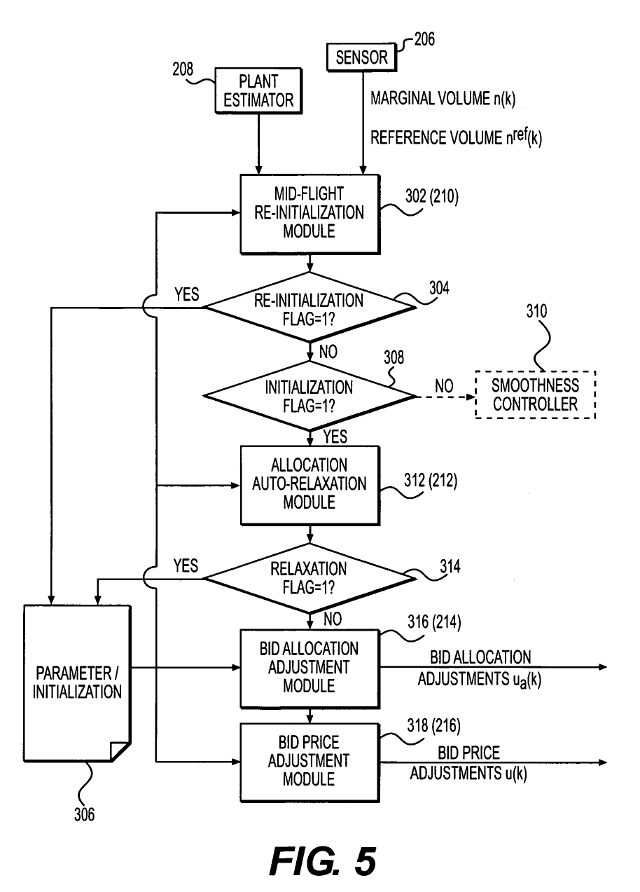

FIG. 5 depicts a flow diagram of an exemplary operation of initialization controller 202. In one embodiment, initialization controller 202 may start at the beginning of the campaign (k=0), and calculate the price control signal u(k) and allocation control signal uₐ(k) at each sampling period during the initialization phase (0≦k≦kₘₐₓ, where kₘₐₓ may be determined by a design parameter, such as kₘₐₓ=65). As shown in FIG. 5, at each sampling time k, initialization controller 202 may be provided with the inputs obtained by sensor 206, such as marginal volume n(k), and/or reference volume n^{ref}(k). In certain embodiments, initialization controller 202 may process the inputs and parameters using mid-flight re-initialization module 210, allocation auto-relaxation module 212, bid allocation adjustment module 214, and bid price adjustment module 216 in sequence. Ultimately, initialization controller 202 may produce outputs including the bid allocation control signal uₐ(k) and bid price control signal u(k) for each sampling time k.

Each module in the initialization controller 202 may be initialized in the beginning, and under some conditions defined by plant estimator 208. Allocation auto-relaxation module 212 and mid-flight re-initialization module 210 may be configured to trigger the re-initialization of one or more modules, as described above. Initialization controller 202 may have a set of pre-defined parameters including design parameters and user-specified parameters. In one embodiment, the control process may be started by initializing u(0), which can be specified by the operator, or calculated as:

u(0)=min(u_{max 0}, y_{ref}(0)e^{- β̅}^{₀})

where u_{max 0} is the upper bound specified for u(0), and β̅₀ is the prior estimate of β₀ from a network average.

Referring to FIG. 5, for each time k in a campaign, initialization controller 202 may determine whether there has been a change in a reference signal that justifies re-initialization (step 304). For example, a re-initialization flag may be set to 1 if re-initialization is justified and to 0 otherwise. If there has been a significant change (step 304, YES), initialization controller 202 may initiate parameter initialization process (step 306), so that updated parameters may be provided to mid-flight re-initialization module 210 (step 302) for processing according to the methods described above. For instance, mid-flight re-initialization module 210 may reinitialize parameters used by bid allocation adjustment module 214 and/or bid price adjustment module 216 (step 302). If re-initialization is not justified (step 304, NO), initialization controller 202 may further determine whether the bid price control signal and/or bid allocation control signal should be controlled by a smoothness controller 310 (step 308).

Initialization controller 202 may then determine whether the initial specified max allocation control signal u_{a,max}, is so small that the campaign under-delivers even when the bid price control signal is relatively high (i.e., saturation occurs and the max allocation control signal needs to be increased). If the max allocation control signal is too small (step 314, YES), initialization controller 202 may initiate parameter initialization (step 306), so that updated parameters may then be provided to allocation auto-relaxation module 212 (step 312) for processing according to the methods described above. For instance, allocation auto-relaxation module 212 may generate a new max allocation control signal value αuₐ(kₛ) (step 312).

Finally, initialization controller 202 may process bid allocation adjustment module 214 (step 316) and/or bid price adjustment module 216 (step 318), perhaps in sequence, based on any updated parameters generated by mid-flight re-initialization module 210 and/or allocation auto-relaxation module 212 to generate a bid allocation control signal uₐ(k) and bid price control signal u(k) for each time k of the campaign.

The present method may advantageously leverage the inherent differences between characteristics of the bid price and characteristics of the bid allocation. Specifically, while adjusting bid price may control how high in a bid table the particular bid will fall, adjusting bid allocation may control the likelihood that the given bid will win each impression. By ramping up a campaign's bid allocation from a small value, it may be possible to approximately forecast the increase in delivery, and determine the supply and demand curve for the particular ad market. By estimating delivery based on the network's time-of-day model and allocation based plant volume model, it may be possible to better generate initial bid price control signals based on known characteristics of the ad network and campaign, rather than randomly guessing a starting bid price. Moreover, because initialization controller 202 may be operated at the campaign level, it may be possible to simultaneously adjust the bid allocation and bid price control signals of a single campaign relative to other campaigns. The control of each campaign may occur independent from volumes and bid prices of other campaigns in the network, and therefore, without the need for a centralized controller coordinating bid prices for numerous ad campaigns. Because the campaign level control is decentralized, these methods do not involve the computational or scalability issues associated with traditional central control or constrained optimization methods.

While embodiments of these systems and methods have been described with respect to online advertising, the presently disclosed initialization systems and methods may be as applicable to competitive bidding on any other goods and services. For example, these systems and methods may be applicable to various competitive bidding systems, online auction systems, or any system involving a bid and/or an allocation, such as the online auctioning of products or services, online keyword auctions, etc., or any other control problems for online and offline advertising. In certain embodiments, the initialization embodiments may be applicable to bidding on advertising off-line, for example, in relation to billboards, bulletin boards, direct mail or physical advertising campaigns, television/radio advertising, e-mail advertising, and/or magazine sales. In addition, the presently disclosed systems and methods may be applicable to the auctioning of bandwidth in wired or wireless telecommunications networks, the sale of data storage, the sale of securities, and the sale of travel, shipping, and housing reservations. In certain embodiments, these systems and methods may be used for “beginning to end” control for smooth delivery of advertising campaigns (i.e., not exclusively for initialization). These embodiments may also be applicable to other control systems involving time-of-day patterns or other repeatable patterns, such as servo control systems of hard disk drives.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A system for controlling initialization of an online advertising campaign, the system comprising:
a sensor configured to determine a current condition of the online advertising campaign;
a memory for storing the condition obtained by the sensor, a set of campaign initialization controller instructions, a campaign volume model, and a network average time-of-day pattern;
an estimator configured to predict future campaign performance based on the condition obtained by the sensor, the campaign volume model, and the network average time-of-day pattern; and
an initialization controller configured to generate a bid allocation control signal and generate a bid price control signal based on the future campaign performance predicted by the estimator, according to the instructions stored in the memory, wherein the bid allocation control signal and bid price control signal are used to adjust future performance of the online advertising campaign.

2. The system of claim 1, wherein the sensor is configured to determine a marginal volume and a reference volume of the online advertising campaign.

3. The system of claim 1, wherein the estimator is configured to estimate a marginal volume of the online advertising campaign as a function of an effective allocation control signal and an effective price control signal.

4. The system of claim 1, wherein the estimator is configured to estimate a marginal volume of the online advertising campaign based on a time-of-day pattern for a network on which the online advertising campaign is running.

5. The system of claim 1, wherein the estimator is configured to estimate a marginal volume of the online advertising campaign as a function of an effective allocation control signal, an effective price control signal, and a time-of-day pattern for a network on which the campaign is running.

6. The system of claim 1, wherein the initialization controller is configured to adjust bid price and bid allocation simultaneously and in real-time.

7. The system of claim 1, wherein the initialization controller is configured to generate the bid allocation control signal based on a predetermined ramp-up function.

8. The system of claim 7, wherein the predetermined ramp-up function is a linear function starting from a small number between 0 and 1.

9. The system of claim 4, wherein the initialization controller is configured to generate the bid price control signal based on the marginal volume estimated by the estimator.

10. The system of claim 1, wherein the initialization controller is configured to generate the bid price control signal based on the campaign volume model to achieve a delivery goal.

11. The system of claim 1, wherein the initialization controller is configured to generate the bid price control signal based on the time-of-day pattern to achieve a delivery goal.

12. The system of claim 4, wherein the initialization controller is configured to generate the bid price control signal by recursively estimating a parameter of the campaign volume model, using the network average time-of-day pattern.

13. The system of claim 1, wherein the initialization controller is configured to automatically increase the bid allocation control signal to avoid campaign under-delivery or over-delivery.

14. The system of claim 1, wherein operation of the initialization controller is independent of the size of, or number of, campaigns operating in an advertising network.

15. A computer-implemented method for controlling initialization of an online advertising campaign, the method comprising:
using a sensor to determine a current condition of the online advertising campaign;
storing in a memory, the condition obtained by the sensor, a set of campaign initialization controller instructions, a campaign volume model, and a network average time-of-day pattern;
predicting future campaign performance based on the condition obtained by the sensor, the campaign volume model, and the network average time-of-day pattern;
generating a bid allocation control signal; and
generating a bid price control signal based on the future campaign performance predicted by the estimator, according to the instructions stored in the memory;
wherein the bid allocation control signal and bid price control signal are used to adjust future performance of the online advertising campaign.

16. The method of claim 15, wherein the performance is defined by one of a marginal volume and a reference volume of the online advertising campaign.

17. The method of claim 15, wherein the future campaign performance is defined by a marginal volume of the campaign.

18. The method of claim 17, wherein the marginal volume of the campaign is estimated as a function of an effective allocation control signal and an effective price control signal.

19. The method of claim 17, wherein the marginal volume of the campaign is estimated as a function of a time-of-day pattern of the campaign.

20. The method of claim 17, wherein the marginal volume of the campaign is estimated as a function of an effective allocation control signal, an effective price control signal, and the network average time-of-day pattern.

21. The method of claim 15, wherein the bid allocation control signal is generated based on a predetermined ramp-up function.

22. The method of claim 21, wherein the predetermined ramp-up function is a linear function starting from a small number between 0 and 1.

23. The method of claim 15, wherein the bid price control signal is generated based on the estimated marginal volume.

24. The method of claim 15, wherein the bid price control signal is generated by recursively estimating a parameter of the network average time-of-day pattern.

25. The method of claim 15, wherein the bid price control signal is generated based on the campaign volume model to achieve a delivery goal.

26. The method of claim 15, wherein the bid price control signal is generated based on the time-of-day pattern to achieve a delivery goal.

27. The method of claim 15, wherein the bid price control signal is generated by recursively estimating a parameter of the campaign volume model, using the network average time-of-day pattern.

28. The method of claim 15, wherein the bid allocation control signal is automatically increased to avoid campaign under-delivery or over-delivery.

29. The method of claim 15, wherein generation of the bid allocation control signal and bid price control signal is independent of the size of, or number of, campaigns operating in an advertising network.

30. A computer-implemented method for controlling re-initialization of an online advertising campaign, the method comprising:
using a sensor to determine a current condition of the online advertising campaign;
storing in a memory, the current condition obtained by the sensor, a set of campaign re-initialization controller instructions, a campaign volume model, and a network average time-of-day pattern;
determining whether the current condition exceeds a predetermined re-initialization threshold; and
initiating a re-initialization sequence if the current condition exceeds the predetermined re-initialization threshold, wherein the re-initialization sequence includes:
predicting future campaign performance based on the condition obtained by the sensor, the campaign volume model, and the network average time-of-day pattern;
generating a bid allocation control signal; and
generating a bid price control signal based on the future campaign performance predicted by the estimator, according to the instructions stored in the memory;
wherein the bid allocation control signal and bid price control signal are used to adjust future performance of the online advertising campaign.

31. A computer-readable storage medium storing a computer program which, when executed by a computer, causes the computer to perform a method comprising the steps of:
using a sensor to determine a current condition of an online advertising campaign;
storing in a memory, the condition obtained by the sensor, a set of campaign initialization controller instructions, a campaign volume model, and a network average time-of-day pattern;
predicting future campaign performance based on the performance information obtained by the sensor, the campaign volume model, and the network average time-of-day pattern;
generating a bid allocation control signal; and
generating a bid price control signal based on the future campaign performance predicted by the estimator, according to the instructions stored in the memory;
wherein the bid allocation control signal and bid price control signal are used to adjust future performance of the online advertising campaign.

32. A computer-implemented method for controlling initialization of an online advertising campaign, the method comprising:
using a sensor to determine a current condition of the online advertising campaign;
storing in a memory, the condition obtained by the sensor, a set of campaign initialization controller instructions, a campaign volume model, and a network average time-of-day pattern;
predicting future campaign performance based on the condition obtained by the sensor, the campaign volume model, and the network average time-of-day pattern;
generating a bid price control signal based on the future campaign performance predicted by the estimator, according to the instructions stored in the memory; and
generating a bid allocation control signal, wherein the bid allocation control signal is defined by uₐ(k), with:
$${u}_{a} ( k ) = min ( {u}_{a} ( {k}_{0} ) + \frac{{u}_{a , max} ( {k}_{0} ) - {u}_{a} ( {k}_{0} )}{{T}_{ramp \text{-} up}} ( k - {k}_{0} ) , {u}_{a , max} ( {k}_{0} ) ) for k \geq {k}_{0}$$
for each time k, where u_{a,max 0} defines a maximum allocation control signal, and Tᵣₐₘₚ₋ᵤₚ defines a ramp-up window.
